(19) United States
(12) Patent Application Publication
(10) Pub. No.: US 2005/0071820 A1
(43) Pub. Date: Mar. 31, 2005

(54) Using a debugging framework to enforce best practices in program development

(75) Inventors: Kavitha Srinivas, Rye, NY (US); Darrell Reimer, Tarrytown, NY (US)

Correspondence Address: SCULLY SCOTT MURPHY & PRESSER, PC, 400 GARDEN CITY PLAZA, GARDEN CITY, NY, 11530, US

(73) Assignee: INTERNATIONAL BUSINESS MACHINES CORPORATION, ARMONK, NY (US)

(21) Appl. No.: 10/671,012

(22) Filed: Sep. 25, 2003

(51) Int. Cl. G06F 9/44

(52) U.S. Cl. 717/129

(57) ABSTRACT

Disclosed are a tool and method for monitoring the behavior of a running computer program. The tool observes the behavior of a running program within the context of a large number of defined coding patterns, and automatically flags violations of the coding patterns when they occur. These defined coding patterns can include best practice patterns and problematic coding patterns. The tool, in the preferred embodiment of the invention, does this using a standard debugger to enforce the best practices rules. This is advantageous because debuggers contain the type of information needed both to enforce the rules and to explain the violations of the rules. Moreover, because debuggers are standard tools in developers' arsenal, little or no additional training is required for the user of the tool to detect subtle software defects.

### BACKGROUND OF THE INVENTION

1. Field of the Invention

This invention, generally, relates to debugging computer programs. More specifically, the invention relates to the automatic detection of problematic coding patterns and violations of best practices patterns at program runtime.

2. Background Art

In any large software deployment, subtle coding defects can cause problems in successful deployment of the software due to system outages, or incorrect program behavior. If these defects are left unchecked, they may surface as problems only when the program is deployed in the production environment, or when the program is subjected to considerable load.

Tracking down these defects is extremely difficult in the production environment because of a number of factors. First, the presenting symptoms are usually not unique to a particular type of software defect; several different types of defects can result in the same program behavior at runtime (e.g. an unresponsive system). This fact makes correlating symptoms to specific defects nearly impossible. Second, the presenting symptoms of the defect only manifest themselves during production level loads and production configurations. This means that the defects are often undetected in the testing and debugging of software, and surface under conditions that make the defect tracking process slow, difficult and expensive. Third, the factors that make a piece of code defective are often a complex pattern that may span third party libraries and frameworks, which makes the detection of the defect difficult for an individual developer, unless he or she can gain a global perspective on the software that comprises both the application and the framework layers.

### SUMMARY OF THE INVENTION

An object of this invention is to enable a software developer to track subtle defects in a running program during the development process.

Another object of the invention is to provide a framework for enforcement of a large number of best practices rules in a running program.

A further object of the present invention is to detect automatically problematic coding patterns or violations of best practices patterns at program runtime, with very little intervention required by the user.

These and other objectives are attained with a tool and method for monitoring the behavior of a running computer program. The tool observes the behavior of a running program within the context of a large number of defined coding patterns, and automatically flags violations of the coding patterns when they occur. These defined coding patterns can include best practice patterns and problematic coding patterns. The tool, in the preferred embodiment of the invention, does this using a standard debugger to enforce the coding pattern. This is advantageous because debuggers contain the type of information needed both to enforce the rules and to explain the violations of the rules. Moreover, because debuggers are standard tools in developers' arsenal, little or no additional training is required for the user of the tool to detect subtle software defects.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a software architecture and methodology of the tool of this invention deployed within a software integrated development environment (IDE).

FIG. 2 is a more detailed flow diagram that depicts the methodology employed by the tool of this invention.

FIG. 3 is a flow chart showing a preferred procedure for implementing the present invention.

### DETAILED DESCRIPTION OF THE PREFERRED EMBODIMENTS

The preferred embodiment of this invention provides a tool that detects violations of formalized coding patterns applicable to a specific platform (e.g., J2EE or NET) in a running program through a debugger. These coding patterns can include best practice patterns and problematic coding patterns.

FIG. 1 is a diagram that depicts a software architecture 10 and methodology of the preferred tool of the invention deployed within a software integrated development environment (IDE). In this embodiment, a developer writes code 12 in an IDE. The developer also typically has test cases 14 to run this code (along with dependent libraries or middleware) within this IDE. The tool 16 provides a mechanism to hook into the debugger 18 within the IDE, such that when the test cases are run by the developer in the debug mode, violations of formalized best practices rules can be automatically detected.

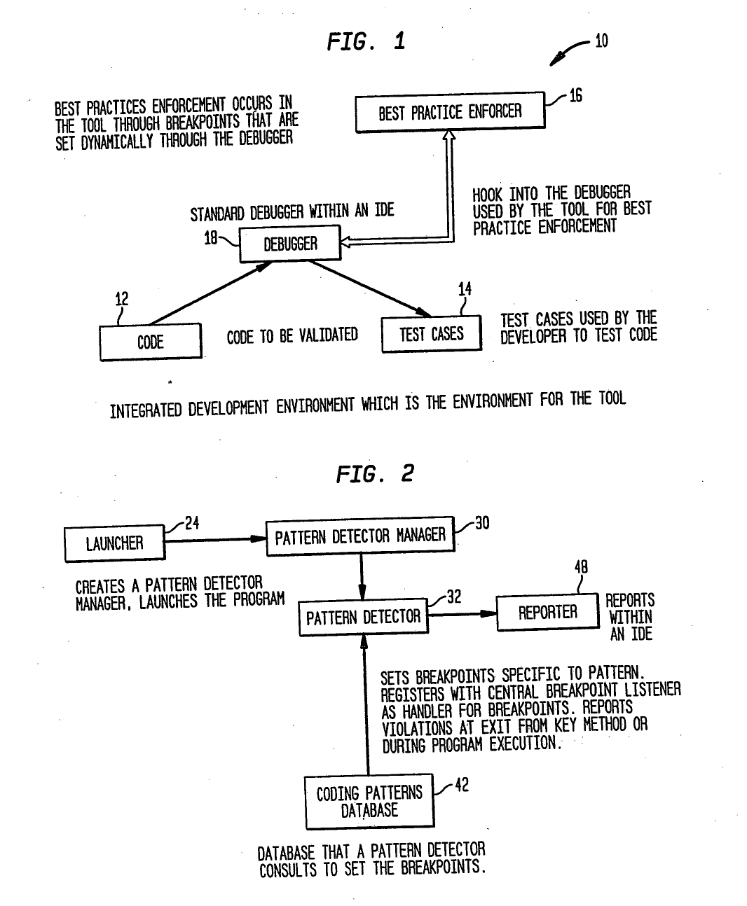

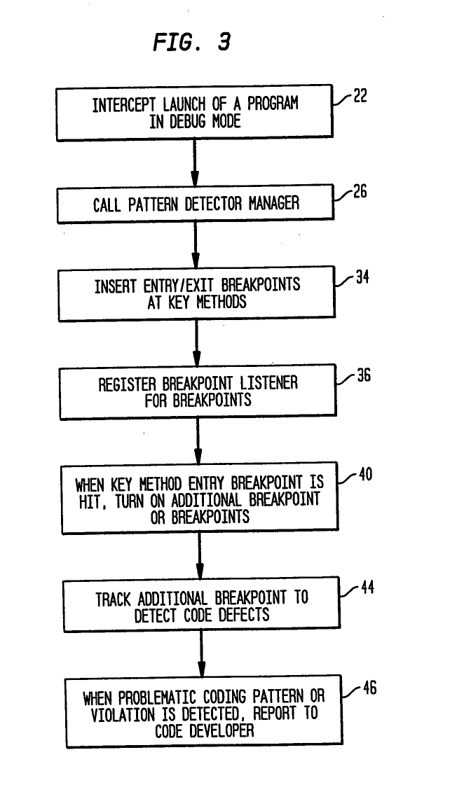

FIGS. 2 and 3 are more detailed flow diagrams which depict the methodology employed by the tool 16. The steps and components involved in enforcement of best practice patterns in a running program are discussed below.

At step 22, the launch of a program within debug mode is intercepted by a component 24 referred to as the launcher, and at step 26, a pattern detector manager 30 is called. The launcher is the component that intercepts the launch, and the pattern detector manager is a component that manages the different pattern detectors 32 that operate within the tool. At step 34, the pattern detector manager automatically inserts entry/exit breakpoints at key methods. This is usually at one or more main entry points into the program (e.g., a program's main method).

As represented at step 36, the pattern detector manager registers a breakpoint listener for this breakpoint. As represented by step 40, upon hitting the key method entry breakpoint, each pattern detector that is in the control of the pattern detector manager is then instructed by the pattern detector manager to turn on additional breakpoints necessary to identify the first step(s) in identifying their respective defect patters. To set these additional breakpoints, the pattern detector may consult a coding patterns database 42.

At step 44, each pattern detector tracks these additional breakpoints to detect code defects, and dynamically turns on or off breakpoints based on the breakpoints that are hit for the pattern. When a pattern detector identifies a problematic coding pattern or a violation of a best practice, the violation is, at step 46, reported by reporter 48 as a defect to the developer. A pattern detector can identify a violation either by a series of events happening which should not happen or by expected events being missing when program execution or the trace code segment completes.

As an example, assume that there are four pattern detectors within the tool 16 that detect violations of the following four types of best practice patterns:
1. Must call X after a call to Y, which detects that a method X is called after a call to method Y on the same object.
2. Never call X from Y, which detects if a method X was called from method Y either directly or indirectly through a number of intervening method calls.
3. Do not call X from Y more than Z times, which detects if a method X was called from method Y directly or indirectly more than Z times.
4. Do not store objects that are greater than size Z in X through method Y, which makes sure that the total size of objects that are stored in object X through the method Y is not greater than Z.

In this example, the launcher 24 intercepts program launch in debug mode, and calls the pattern detector manager 30 to set a key breakpoint for entry into the main method. When the main method entry level breakpoint is hit, each of the pattern detectors is called to set additional pattern specific breakpoints. In the example, each of the pattern detectors sets the following set of breakpoints, and tracks them through program execution.

The Must call X after a call to Y pattern detector will set breakpoints at both methods X and Y. When method Y is called on an object, the reference to that object is stored into a data structure maintained by the pattern detector and a breakpoint is inserted at method X. When method X is called on an object, the reference to the object is removed from the data structure, and if no references remain in the data structure, the breakpoint on method X is removed. At exit from the key method of the program, any object references left in the data structure of the pattern detector are objects where a call to Y was not followed by a call to X. These objects are then reported to the user as violations of the Must call X after a call to Y best practice.

The Never call X from Y pattern detector will first place a breakpoint at Y. If the Y breakpoint is hit in the course of program execution, an additional breakpoint will be added at method X. If the program hits any breakpoint at X, then a violation of the Never call X from Y rule will be reported to the user. When method Y completes, the breakpoint on method X is removed.

The Do not call X from Y more than Z times pattern detector will also place a breakpoint at Y. If the Y breakpoint is hit in the course of program execution, an additional breakpoint will be added at method X. If the breakpoint to X is hit more than Z times, then a violation of the Do not call X from y more than Z times will be reported to the user, and the breakpoint at X will be removed. When method Y completes, the breakpoint on method X is removed.

The Do not store objects that are greater than size Z in X through method Y pattern detector will place a breakpoint in method Y that allows an object to be stored in S. Each store is then checked against size Z. Any store above size Z will be reported as a violation to the user.

To achieve the desired performance and scalability, preferably the tool has the following features.

First, the tool uses a cascading system of breakpoints that are applied to a running program to enforce a best practice pattern. Only the breakpoints necessary for detecting the “next” step in a pattern are active at any given time. This is advantageous both to control the number of breakpoints that need to be active at any given time and to minimize the overhead of running an application in this environment. Specifically, if the beginning elements of a pattern are never encountered within the program execution, this technique ensures that the execution of a program is not slowed due to the setting of breakpoints for later elements of the pattern.

Second, once the later elements of a pattern are detected, and a violation is flagged, then the breakpoint is removed dynamically. An example of this is where X is called from Y more than Z times. In this case, the breakpoint at X may be removed, because the pattern detector has reached the exit condition. Again, this has beneficial effects on performance such that breakpoints that are no longer needed for pattern detection are removed dynamically during program execution.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A tool for monitoring the behavior of a running computer program, comprising:
a pattern detector manager for inserting into a running computer program a plurality of entry breakpoints, each of said entry breakpoints being associated with one of a plurality of defined coding patterns; and
a pattern detector for determining, after one of the entry breakpoints is reached in the computer program, whether the program violates the coding pattern associated with said reached breakpoint.

2. A tool according to claim 1, wherein the pattern detector manager automatically inserts a plurality of breakpoints for pattern detection, with little or no intervention from the user.

3. A tool according to claim 1, wherein, when one of the entry breakpoints is reached in the computer program, the pattern detector manager inserts into the program at least one further breakpoint, each further breakpoint identifying a respective step in the program that is part of the coding pattern associated with said one of the entry breakpoints.

4. A tool according to claim 1, for use with a debugger for debugging the computer program, and further including a launcher to invoke the pattern detector manager when the debugger is used to debug the program.

5. A tool according to claim 1, wherein the pattern detector manager removes the entry breakpoints at specified times.

6. A tool according to claim 3, wherein the pattern detector manager removes the entry breakpoints and the further breakpoints at specified times.

7. A tool according to claim 3, wherein:
the pattern detector manager includes means for monitoring for the occurrences of the entry breakpoints; and
the pattern detector manager inserts said at least one further breakpoint into the computer program in response to the monitoring means detecting the occurrence of said one of the entry breakpoints.

8. A tool according to claim 1, wherein the plurality of defined coding patterns are selected from the group comprising best practice patterns and problematic coding patterns.

9. A method for monitoring the behavior of a running computer program, comprising the steps:
inserting into a running computer program a plurality of entry breakpoints, each of said entry breakpoints being associated with one of a plurality of defined coding patterns; and
determining, after one of the entry breakpoints is reached in the computer program, whether the program violates the coding pattern associated with said reached breakpoint.

10. A method according to claim 9, wherein the inserting step includes the step of, when one of the entry breakpoints is reached in the computer program, inserting into the program at least one further breakpoint, each further breakpoint identifying a respective step in the program that is part of the coding pattern associated with said one of the entry breakpoints.

11. A method according to claim 9, for use with a debugger for debugging the computer program, and further including the step of invoking the pattern detector manager when the debugger is used to debug the program.

12. A method according to claim 9, wherein further including the step of removing the entry breakpoints at specified times.

13. A method according to claim 10, wherein further including the step of removing the entry breakpoints and the further breakpoints at specified times.

14. A method according to claim 10, wherein the step of inserting the at least one further breakpoint into the computer program includes the steps of:
monitoring for the occurrences of the entry breakpoints; and
inserting said at least one further breakpoint into the computer program in response to detecting the occurrence of said one of the entry breakpoints.

15. A program storage device readable by machine, tangibly embodying a program of instructions executable by the machine to perform method steps for monitoring the behavior of a running computer program, said method steps comprising:
inserting into a running computer program a plurality of entry breakpoints, each of said entry breakpoints being associated with one of a plurality of defined coding patterns; and
determining, after one of the entry breakpoints is reached in the computer program, whether the program violates the coding pattern associated with said reached breakpoint.

16. A program storage device according to claim 15, wherein the inserting step includes the step of, when one of the entry breakpoints is reached in the computer program, inserting into the program at least one further breakpoint, each further breakpoint identifying a respective step in the program that is part of the coding pattern associated with said one of the entry breakpoints.

17. A program storage device according to claim 15, for use with a debugger for debugging the computer program, and wherein said method steps include the further step of invoking the pattern detector manager when the debugger is used to debug the program.

18. A program storage device according to claim 15, wherein said method steps include the further step of removing the entry breakpoints at specified times.

19. A program storage device according to claim 16, wherein said method steps include the further step of removing the entry breakpoints and the further breakpoints at specified times.

20. A program storage device according to claim 15, wherein step of inserting the at least one further breakpoint into the computer program includes the steps of:
monitoring for the occurrences of the entry breakpoints; and
inserting said at least one further breakpoint into the computer program in response to detecting the occurrence of said one of the entry breakpoints.
